(19) United States
(12) Patent Application Publication
(10) Pub. No.: US 2015/0043488 A1
(43) Pub. Date: Feb. 12, 2015

(54) Method and Apparatus for a User Equipment

(71) Applicant: Broadcom Corporation, Irvine, CA (US)

(72) Inventors: Sami-Jukka HAKOLA, Kempele (FI); Samuli TURTINEN, Ii (FI); Timo Kalevi KOSKELA, Oulu (FI)

(21) Appl. No.: 14/455,155

(22) Filed: Aug. 8, 2014

(30) Foreign Application Priority Data
Aug. 9, 2013 (GB) 1314325.0

(51) Int. Cl. H04W 48/16; H04W 76/02; H04W 4/00

(52) U.S. Cl. CPC H04W 48/16; H04W 4/008; H04W 76/023
USPC 370/329

(57) ABSTRACT

The present invention addresses a method, apparatus and computer program product for enabling concurrent Proximity Services and infrastructure based communication. An ability for Proximity Services application is determined, a resource of a scheduled uplink transmission, scheduled by a network, in the transmission time interval following a transmission time interval during which a discovery message for Proximity Services application has been transmitted or received is modified, wherein the resource is shortened in time, and transmission of the shortened scheduled uplink transmission is caused.

### TECHNICAL FIELD

Embodiments of the present invention generally relate to concurrent Proximity Services and infrastructure based communication, and in particular to a method, apparatus and computer program product for avoiding timing interferences in concurrent Proximity Services and infrastructure based communication.

### BACKGROUND

Mobile data transmission and data services are constantly making progress, wherein such services provide various communication services, such as voice, video, packet data, messaging, broadcast, etc. Furthermore, in recent years such systems and network elements thereof also enable Proximity Services (ProSe).

Generally, radio resources for Proximity Services Discovery, ProSe Communication and infrastructure based communication (i.e. normal cellular communication) are under continuous network control in commercial spectrum and in public safety spectrum when user equipments UEs are under network coverage. A user equipment UE when in connected mode is configured with a timing advance (TA) value by the serving base station (e.g. evolved NodeB eNB).

In the current ProSe Technical Report (i.e. prior art document [1]) provided by 3GPP SA1, the following service requirement is given:

“Subject to operator policy and user consent, a ProSe-enabled UE should be capable of establishing the E-UTRAN infrastructure path and ProSe communication path concurrently.”

The requirement basically means that the UE shall be able to have active IP flows/bearers on both infrastructure and ProSe communication path concurrently. Correspondingly the same requirement should hold between ProSe discovery and infrastructure based communication.

In prior art document [2] the following is specified:

“For a timing advance command received on subframe n, the corresponding adjustment of the uplink transmission timing shall apply from the beginning of subframe n+6. For serving cells in the same TAG, when the UE″s uplink PUCCH/PUSCH/SRS transmissions in subframe n and subframe n+1 are overlapped due to the timing adjustment, the UE shall complete transmission of subframe n and not transmit the overlapped part of subframe n+1.”

However, when discovery resources take place on uplink resources, the UE will have different transmission timing parameters for the cellular communication and ProSe, e.g. for ProSe Discovery. That is because the discovery among UEs may have a common timing independent of individual TA values of the UEs.

FIG. 1 illustrates the situation that shows downlink timing at the serving eNB, uplink cellular transmission timing of two UEs and common discovery transmission timing among UEs participating in the discovery process.

The problem considered here is the situation when a UE is transmitting a discovery transmission on a transmission time interval (TTI) TTI n and then it has a scheduled uplink transmission on TTI n+1, the transmission timing for both TTIs are different and the UE may not able to adjust transmission timing for the TTI n+1.

### REFERENCES

[1] 3GPP S1-124203
[2] 3GPP TS 36.213 V11.0.0 “Physical layer procedures (Release 11)”

### SUMMARY

It is an aim of the present invention to provide an apparatus, a method and a computer program product for enabling concurrent Proximity Services and infrastructure based communication.

According to a first aspect of the present invention, a method comprises the steps of determining ability for Proximity Services application, modifying a resource of a scheduled uplink transmission, scheduled by a network, in the transmission time interval following a transmission time interval during which a discovery message for Proximity Services application has been transmitted or received, wherein the resource is shortened in time, and causing transmission of the shortened scheduled uplink transmission.

According to a second aspect of the present invention, an apparatus comprises a processing system arranged to cause the apparatus at least to perform determining ability for Proximity Services application, modifying a resource of a scheduled uplink transmission, scheduled by a network, in the transmission time interval following a transmission time interval during which a discovery message for Proximity Services application has been transmitted or received, wherein the resource is shortened in time, and causing transmission of the shortened scheduled uplink transmission.

The processing system may comprise at least one processor and at least one memory including computer program code.

According to a third aspect of the present invention, there is provided a computer program product comprising computer-executable components which, when the program is run on a computer, are configured to carry out the method according to the first aspect.

According to a fourth aspect of the present invention, an apparatus, comprises determining means for determining ability for Proximity Services application, modification means for modifying a resource of a scheduled uplink transmission, scheduled by a network, in the transmission time interval following a transmission time interval during which a discovery message for Proximity Services application has been transmitted or received, wherein the resource is shortened in time, and processing means for causing transmission of the shortened scheduled uplink transmission.

Advantageous further developments or modifications of the aforementioned exemplary aspects of the present invention are set out in the dependent claims.

### BRIEF DESCRIPTION OF DRAWINGS

For a more complete understanding of example embodiments of the present invention, reference is now made to the following descriptions taken in connection with the accompanying drawings in which:

FIG. 1 shows a timing chart illustrating a drawback of the prior art;

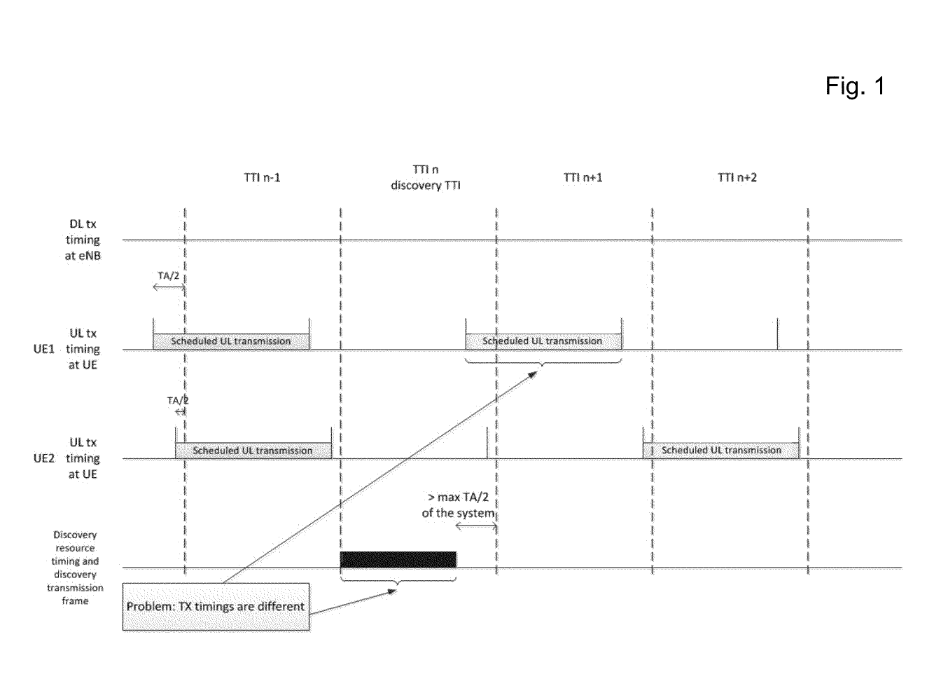

FIG. 2 shows a principle flowchart of an example for a method according to certain embodiments of the present invention;

FIG. 3 shows a principle configuration of an example for an apparatus according to certain embodiments of the present invention;

FIG. 4 illustrates a user equipment behavior according to certain embodiments of the present invention; and

FIG. 5 shows a user equipment-network signaling diagram according to certain embodiments of the present invention.

### DETAILED DESCRIPTION

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE™/LTE™-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to certain embodiments of the present invention, a scheduled uplink transmission on TTI n+1 following a TTI n on which a ProSe-enabled UE has transmitted or received a discovery message shall be a shortened version of the normal uplink scheduled transmission in time.

This is applicable in the case the scheduled uplink transmission takes place on the same frequency channel as the discovery transmission or reception or in case when the scheduled uplink transmission takes place on other frequency channel but the UE is not capable of having independent timings for the ProSe and normal cellular communication.

For instance, the UE may be capable of having multiple transmission timing values in intra-band operation or the capability may be band specific. The UE should signal its radio capability related to concurrent use of ProSe and cellular communication to the EUTRAN.

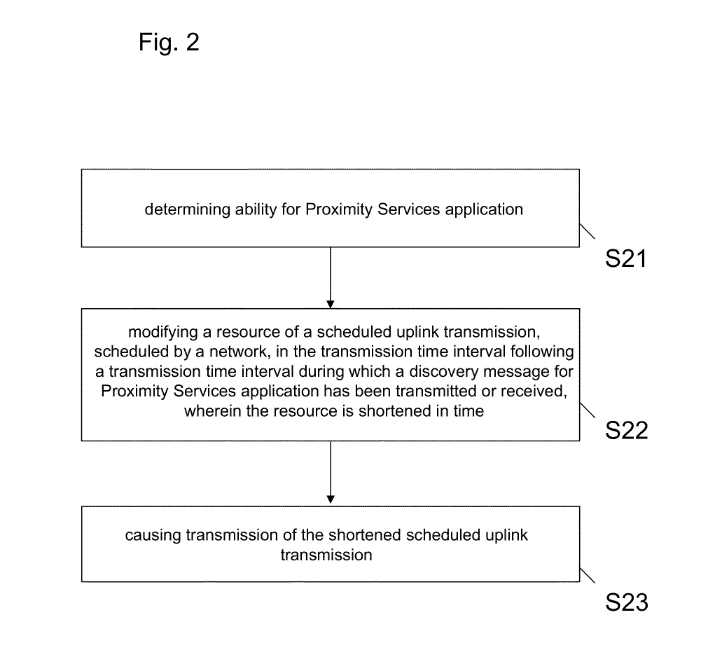

FIG. 2 shows a principle flowchart of an example for a method according to certain embodiments of the present invention.

In Step S21, ability for Proximity Services application is determined.

In Step S22, a resource of a scheduled uplink transmission, scheduled by a network, in the transmission time interval following a transmission time interval during which a discovery message for Proximity Services application has been transmitted or received is modified, wherein the resource is shortened in time.

In Step S23, transmission of the shortened scheduled uplink transmission is caused.

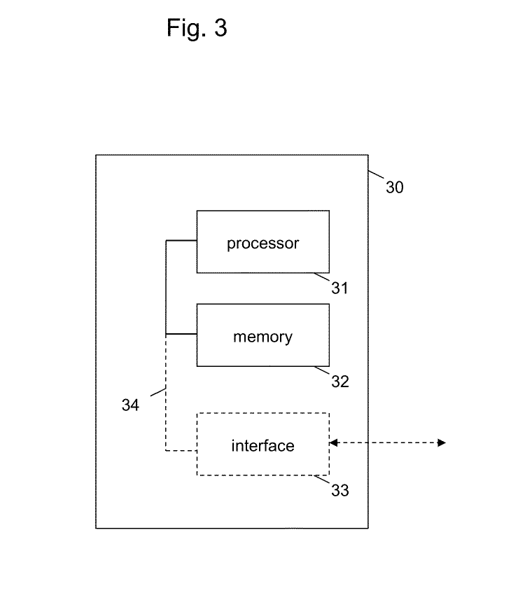

FIG. 3 shows a principle configuration of an example for an apparatus according to certain embodiments of the present invention. The apparatus 30 comprises at least one processor 31 and at least one memory 32 including computer program code, which are connected by a bus 33 or the like.

The at least one memory 32 and the computer program code are arranged to, with the at least one processor 31, cause the apparatus 30 at least to perform determining ability for Proximity Services application, modifying a resource of a scheduled uplink transmission, scheduled by a network, in the transmission time interval following a transmission time interval during which a discovery message for Proximity Services application has been transmitted or received, wherein the resource is shortened in time, and causing transmission of the shortened scheduled uplink transmission.

According to certain embodiments of the present invention, the modified scheduled uplink transmission is shortened in symbol level.

According to certain embodiments of the present invention, the modified scheduled uplink transmission is shortened by one symbol at the beginning of the transmission time interval following the transmission time interval during which the discovery message for Proximity Services application has been transmitted or received.

According to certain embodiments of the present invention, in case of a scheduled uplink transmission on a transmission time interval before the transmission time interval during which the discovery message for Proximity Services application has been transmitted or received, the scheduled uplink transmission is shortened from the end of the transmission time interval.

According to certain embodiments of the present invention, modifying the resource of the scheduled uplink transmission is carried out in case the scheduled uplink transmission takes place on the same frequency channel as the discovery transmission or reception

According to certain embodiments of the present invention, modifying the resource of the scheduled uplink transmission is carried out in case the scheduled uplink transmission takes place on a different frequency channel as the discovery transmission or reception, when it is determined that having independent timings for the Proximity Services application and normal cellular communication are not capable.

According to certain embodiments of the present invention, a threshold value for the time difference between the transmission time interval during which the discovery message for Proximity Services application has been transmitted or received and the transmission time interval following the transmission time interval during which the discovery message for Proximity Services application has been transmitted or received is set, and modification of the resource is carried out in case the time difference exceeds the threshold value.

According to certain embodiments of the present invention, an offset value for the threshold value is set, which is used for triggering modification of the resource.

According to certain embodiments of the present invention, when the time difference is equal or larger than the sum of the threshold value and the offset value, modification of the resource is carried out, and when the time difference is smaller or equal than the difference of the threshold value and the offset value, it is indicated to the network that modifying the scheduled uplink transmission is no longer needed.

According to certain embodiments of the present invention, the threshold value and/or the offset value is configured by the network.

According to certain embodiments of the present invention, a prohibit timer for prohibiting transmission to the network is triggered upon indicating shortened scheduled uplink transmission to the network.

All the mentioned embodiments can be formed in several alternatives as illustrated but not limited to the implementation examples shown below.

As already indicated above, according to certain embodiments of the present invention, a scheduled uplink transmission on TTI n+1 following a TTI n on which a ProSe-enabled UE has transmitted or received a discovery message shall be a shortened version of the normal uplink scheduled transmission in time.

In case the time difference between discovery TTI n and TTI n+1 is sufficiently small, the UE may use the specified method as presented in the prior art. In case the time difference falls beyond a specified/configured threshold, UE could indicate to the network that UL transmissions after each discovery TTI should be shortened in symbol level, e.g., shorten the transmission by one symbol at the beginning of TTI n+1.

The threshold value can be subject to used cyclic prefix length in the system (normal and long CP for instance) and can be equal, shorter, or longer to the used cyclic prefix length. The threshold value could be specified or configurable by the network.

Additionally, network could configure an offset value when to trigger the indication to the network (i.e., either that the shortening is needed or the shortening is not needed anymore) which would be used to avoid “ping-pong” effect when the time difference is varying very nearby the threshold value. In other words, when the time difference T_{differ}>=T_{threshold}+offSet→indicate the need of shortening and vice versa when the shortening is applied and the time difference T_{differ}<=T_{threshold}−offset→indicate the shortening is no longer needed.

Alternatively, a prohibit timer may be utilized to avoid frequent reportings by the UE. The prohibit timer value could be configurable by the network and would be applied when the indication is sent to the network. In one option, the prohibit timer would be triggered and applied only when the UE indicates the shortening of the TTI is needed but not when the UE indicates the shortening is no longer needed. The reasoning is that even though shortening would not be needed, it does not break the system but if the shortening is needed and the UE is prohibited to indicate that to the network, UE transmissions in TTI n+1 could be lost.

Since the scheduling grant is sent four TTIs earlier on downlink to the UE, it may either be:

a) specified that UE always uses a shortened uplink transmission if the scheduled uplink transmission follows a discovery TTI when the UE has been configured to be able to discover other UEs and/or to be discoverable by other UEs (i.e. to receive and/or send discovery messages). In case of adaptive retransmission for the earlier scheduled uplink transmission, the eNB may indicate on PDCCH whether UE could be able to transmit a discovery transmission on TTI n and a shortened uplink transmission on TTI n+1 or only uplink transmission on TTI n+1 with normal duration of 1 ms.

b) specified that eNB has a possibility to order the UE to use the normal TTI duration for the scheduled UL transmission on TTI n+1. In this case, the UE in question shall not transmit/listen to a discovery transmission on TTI n. The same would apply to the case where UE would have a non-adaptive retransmission on TTI n+1.

The above embodiments could be generalized to apply also for the scheduled UL transmission on TTI before the ProSe TTI for the UE in question. In that case the scheduled uplink transmission shall be shortened from the end of the TTI.

The length of shortened TTI may be fixed by the specifications or configured by the network.

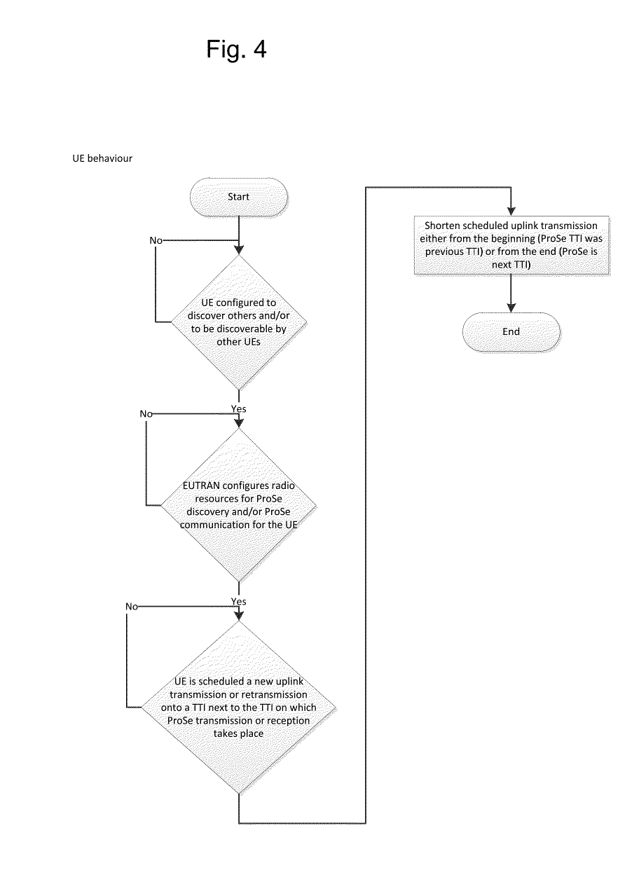

FIG. 4 illustrates a user equipment behavior according to certain embodiments of the present invention.

First, it is determined whether the UE is configured to discover other UEs and/or is discoverable by other UEs for Proximity Services applications. If so, the network (e.g. EUTRAN) configures radio resources for ProSe discovery and/or ProSe communication for the UE.

Thereupon, the UE is scheduled a new uplink transmission or retransmission onto a TTI next to the TTI on which the ProSe transmission or reception takes place.

Then, the scheduled uplink transmission is shortened either from the beginning, in case the ProSe-TTI was the previous TTI, or from the end, in case the ProSe-TTI is the next TTI.

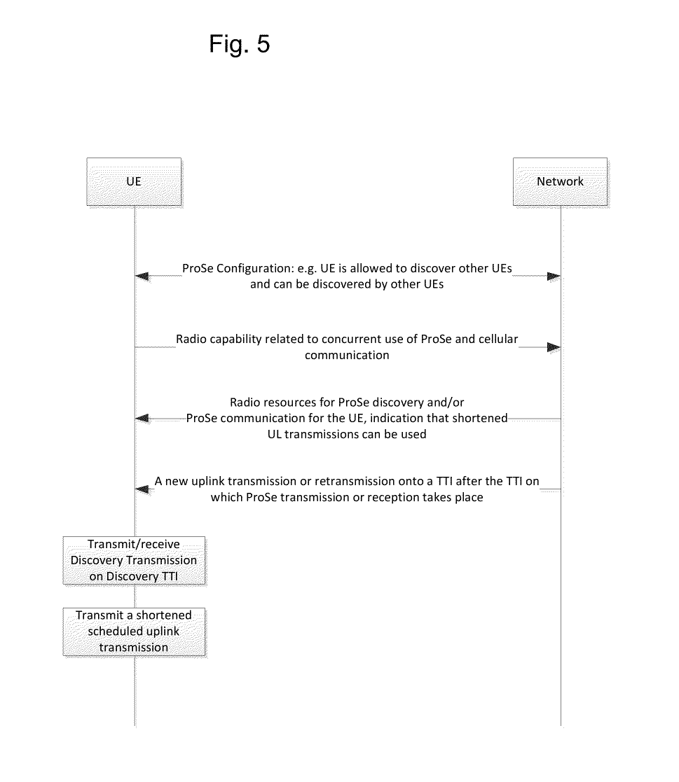

FIG. 5 shows a UE-Network signaling diagram according to certain embodiments of the present invention.

First, a ProSe configuration is signaled, wherein it is indicated e.g. that the UE is allowed to discover other UEs and can be discovered by other UEs. That is, a determination of an ability for Proximity Services application is performed.

Radio capability related to concurrent use of ProSe and cellular communication is indicated to the network.

Further, the network indicates to the UE about radio resources for ProSe discovery and/or ProSe communication, and may indicate that shortened uplink transmissions can be used.

A new uplink transmission or retransmission onto a TTI after the TTI on which a ProSe transmission or reception takes place may be indicated to the UE.

When a discovery transmission on discovery TTI is transmitted or received, a shortened scheduled uplink transmission is transmitted.

In the foregoing exemplary description of the apparatus, only the units that are relevant for understanding the principles of the invention have been described using functional blocks. The apparatuses may comprise further units that are necessary for its respective function. However, a description of these units is omitted in this specification. The arrangement of the functional blocks of the apparatuses is not construed to limit the invention, and the functions may be performed by one block or further split into sub-blocks.

According to exemplarily embodiments of the present invention, a system may comprise any conceivable combination of the thus depicted devices/apparatuses and other network elements, which are arranged to cooperate as described above.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer or smart phone, or user equipment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The present invention relates in particular but without limitation to mobile communications, for example to environments under LTE, LTE-A, WCDMA, WIMAX and WLAN and can advantageously be implemented in user equipments or smart phones, or personal computers connectable to such networks. That is, it can be implemented as/in chipsets to connected devices, and/or modems thereof.

According to the present invention, user equipment may refer to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following meanings for the abbreviations used in this specification apply:

3GPP 3rd Generation Partnership Project

D2D Device-to-Device

DL Downlink

eNB Enhanced Node B

ePDCCH Enhanced Physical Downlink Control Channel

LTE Long Term Evolution

ProSe Proximity Services

PUCCH Physical Uplink Control Channel

PUSCH Physical Uplink Shared Channel

RRC Radio Resource Control

Rx Receive

Tx Transmit

TTI Transmission Time Interval

UE User Equipment

UL Uplink

1. A method, comprising:
determining ability for Proximity Services application;
modifying a resource of a scheduled uplink transmission, scheduled by a network, in the transmission time interval following a transmission time interval during which a discovery message for Proximity Services application has been transmitted or received, wherein the resource is shortened in time; and
causing transmission of the shortened scheduled uplink transmission.

2. The method according to claim 1, wherein the modified scheduled uplink transmission is shortened at a symbol level.

3. The method according to claim 2, wherein the modified scheduled uplink transmission is shortened by one symbol at the beginning of the transmission time interval following the transmission time interval during which the discovery message for Proximity Services application has been transmitted or received.

4. The method according to claim 2, wherein in case of a scheduled uplink transmission on a transmission time interval before the transmission time interval during which the discovery message for Proximity Services application has been transmitted or received, the scheduled uplink transmission is shortened from the end of the transmission time interval.

5. The method according to claim 1, wherein modifying the resource of the scheduled uplink transmission is carried out in case the scheduled uplink transmission takes place on the same frequency channel as the discovery transmission or reception.

6. The method according to claim 1, wherein modifying the resource of the scheduled uplink transmission is carried out in case the scheduled uplink transmission takes place on a different frequency channel as the discovery transmission or reception, when it is determined that having independent timings for the Proximity Services application and normal cellular communication are not capable.

7. The method according to claim 1, wherein a threshold value for the time difference between the transmission time interval during which the discovery message for Proximity Services application has been transmitted or received and the transmission time interval following the transmission time interval during which the discovery message for Proximity Services application has been transmitted or received is set, and modification of the resource is carried out in case the time difference exceeds the threshold value.

8. The method according to claim 1, wherein a prohibit timer for prohibiting transmission to the network is triggered upon indicating shortened scheduled uplink transmission to the network.

9. An apparatus for use in a user equipment, comprising:
a processing system comprising at least one processor and a memory storing a computer program, the processing system arranged to cause the apparatus at least to:
determine ability for Proximity Services application;
modify a resource of a scheduled uplink transmission, scheduled by a network, in the transmission time interval following a transmission time interval during which a discovery message for Proximity Services application has been transmitted or received, wherein the resource is shortened in time; and
cause transmission of the shortened scheduled uplink transmission.

10. The apparatus according to claim 9, wherein the modified scheduled uplink transmission is shortened at a symbol level.

11. The apparatus according to claim 10, wherein the modified scheduled uplink transmission is shortened by one symbol at the beginning of the transmission time interval following the transmission time interval during which the discovery message for Proximity Services application has been transmitted or received.

12. The apparatus according to claim 10, wherein in case of a scheduled uplink transmission in a transmission time interval before the transmission time interval during which the discovery message for Proximity Services application has been transmitted or received, the scheduled uplink transmission is shortened from the end of the transmission time interval.

13. The apparatus according to claim 9, wherein modifying of the resource of the scheduled uplink transmission is carried out in case the scheduled uplink transmission takes place on the same frequency channel as the discovery transmission or reception.

14. The apparatus according to claim 9, wherein modifying the resource of the scheduled uplink transmission is carried out in case the scheduled uplink transmission takes place on a different frequency channel as the discovery transmission or reception, when it is determined that having independent timings for the Proximity Services application and normal cellular communication are not capable.

15. The apparatus according to claim 9, wherein the processing system is further arranged to set a threshold value for the time difference between the transmission time interval during which the discovery message for Proximity Services application has been transmitted or received and the transmission time interval following the transmission time interval during which the discovery message for Proximity Services application has been transmitted or received, wherein modification of the resource is carried out in case the time difference exceeds the threshold value.

16. The apparatus according to claim 15, wherein the processing system is further arranged to set an offset value for the threshold value, which is used for triggering modification of the resource.

17. The apparatus according to claim 16, wherein, when the time difference is equal or larger than the sum of the threshold value and the offset value, modification of the resource is carried out; and when the time difference is smaller than or equal to the difference of the threshold value and the offset value, it is indicated to the network that modifying the scheduled uplink transmission is no longer needed.

18. The apparatus according to claim 15, wherein the threshold value and/or the offset value is configured by the network.

19. The apparatus according to claim 9, wherein the processing system is further arranged to trigger a prohibit timer for prohibiting transmission to the network upon indicating shortened scheduled uplink transmission to the network.

20. A computer readable memory tangibly storing a computer program which is executable by a processor, the computer program comprising:
code for determining ability for Proximity Services application;
code for modifying a resource of a scheduled uplink transmission, scheduled by a network, in the transmission time interval following a transmission time interval during which a discovery message for Proximity Services application has been transmitted or received, wherein the resource is shortened in time; and
code for causing transmission of the shortened scheduled uplink transmission
